(19) United States
(12) Patent Application Publication
(10) Pub. No.: US 2018/0349998 A1
(43) Pub. Date: Dec. 6, 2018

(54) MODELING AND COMPARING BEHAVIOR OF MULTIPLE TRADING OPPORTUNITIES FOR OPTIONS

(71) Applicant: Morris Donald Scott PUMA, San Francisco, CA (US)

(72) Inventor: Morris Donald Scott PUMA, San Francisco, CA (US)

(21) Appl. No.: 15/956,737

(22) Filed: Apr. 18, 2018

Related U.S. Application Data
(60) Provisional application No. 62/486,788, filed on Apr. 18, 2017.

(51) Int. Cl. G06Q 40/04; G06F 17/30; G06F 17/18; G06Q 40/06

(52) U.S. Cl. CPC G06Q 40/04; G06Q 40/06; G06F 17/18; G06F 17/30994

(57) ABSTRACT

An options server device on a data communication network to predict options behavior for comparison to other options. Now the trader can design more effective options spreads with the predicted relationships between multiple options prices and knowing the exact future price of options is not so critical. Users are provided with a simple interface, to apply formulas to thousands of options simultaneously and to view the results of the formulas in a visual format that is simple to interpret. By applying one formula at a time to a plurality of options, a user can gain insight to their relative behavior.

### CROSS-REFERENCE TO RELATED PATENT APPLICATIONS

This application claims priority under 35 USC 119(e) to U.S. Provisional Patent Application No. 62/486,788, filed Apr. 18, 2017, by Morris Donald Scott Puma, and entitled MODELING AND COMPARING BEHAVIOR OF MULTIPLE TRADING OPPORTUNITIES FOR OPTIONS, and is related to U.S. patent application Ser. No. 14/540,035, filed on Nov. 12, 2014, by Morris Puma, now abandoned, U.S. Patent Application No. 61/902,758, filed on Nov. 11, 2013, by Morris Puma, and U.S. application Ser. No. 14/312,662, filed on Jun. 23, 2014 by Morris Puma, now abandoned, the contents of each being hereby incorporate by reference in their entirety.

### FIELD OF THE DISCLOSURE

The invention relates generally to computer applications, and more specifically, to a remote options server to model and compare the behavior of multiple or singular options together or separately, accurately and quickly.

### BACKGROUND OF THE DISCLOSURE

Options are complex and some of their attributes include option Greeks, volatility, option prices, days to expiration and the price of the underlying. Price changes of options are affected by many aspects such as moneyness, days to expiration, changes in time, volatility, underlying price moves, interest rates, liquidity and pending news, just to name a few. Since so many things affect an options price, they are somewhat unpredictable.

Current computer software does not compare the characteristics of options and display the comparative, relative results to the options trader. Current software does not compare and display the changes in characteristics of options relative to other changes either, such as time, changes in volatility and changes in price. Current software does not provide a user with a method to apply formulas to a plurality of options and compare how all options react to the inserted formula. Current software does not display the behavior of options to a user. Therefore, options behavior is unpredictable. Current software does not show a user which expiration cycle to trade, and current software does not statistically help a trader forecast direction of an underlying asset. This lack of information puts option traders at a disadvantage when they buy and sell options.

For example, a trader may want to profit from selling an option that has a high rate of time decay with as little risk as possible. However, there are thousands of options available to the option trader with varying strikes as well as varying days to expiration. SPX offers approximately 8,000 options for trade at any given moment. How can an option trader possibly know which option to sell that meets the requirements? In another example, a trader might wish to buy a call that would increase the most in value if the price of the underlying moved up 5% in 2 weeks. Again, the option trader is faced with the same problem. There is no way to select the optimized option of the thousands available to purchase. Currently, choosing the best option to buy or sell is a guessing game because traders do not have the computerized tools and information they need. In another example, a trader wants to create a time spread, but the trader does not know which month to sell and buy.

### SUMMARY

To overcome the shortcomings of the prior art, computer-implemented methods, non-transitory computer readable media and an options server provide models and comparisons of multiple trading opportunities for options (e.g., in real-time). Advantageously, options behavior is predicted and compared to other options. Now the trader can design more effective options spreads with the predicted relationships between multiple options prices and knowing the exact future price of options is not so critical. Therefore, new technology for comparisons improves another technology in options predictions.

In one embodiment, users are provided with a simple interface (e.g., graphical user interface on an Internet browser or a mobile app), to apply formulas to thousands of options simultaneously and to view the results of the formulas in a visual format that is simple to interpret, in some embodiments, for options predictions. By automatically applying one formula at a time to a plurality of options, with the computer algorithms discussed herein, a user is provided insight to their relative behavior. An embodiment approaches options trading as a behavioral science. Not only does the embodiment clearly illustrate how an option behaves relative its influences, but also provides a user a simple interface to see how thousands of options behave compared to each other. The result is the option trader gains a clear understanding of how options behave alone or compared to other options. An option trader will have an idea of exactly which option is the safest to sell by applying a formula such as theta/price/lambda. Said formula is essentially the rate of decay divided by the rate the price of the option changes. Another measurement that could be compared across all options is theta/gamma. Many traders want to maximize theta and minimize gamma, but they currently do not have the tools to locate which options meet this criteria. With the invention, unlimited information can be displayed to the user. The user is only limited by his/her own creativity or knowledge of options, and in that case, the invention provides many default algorithms for the user to benefit from.

With this technology, an option trader or automated computer processes can know exactly which options create a beneficial pair. For example, a trader would choose a long option for it's slow rate of decay and relative low gamma to price while shorting an options with a higher rate of decay, low gamma relative to its price. Therefore, one technology improves another technology.

In another embodiment, the user can observe the behavior of all options over a period of time. For example, if a user wants to see how all prices changed over the last month compared to each other, the user can do this very simply. This will give the user insight to which options to buy and sell for a future trade.

Due to the number of attributes of options and number of combinations of formulas that can be constructed, there are nearly an infinite amount of formulas that can be passed through each option for comparison. The invention provides an option trader with a tremendous amount of information and a pathway to understand options and their behavior at a much higher level of understanding than ever before.

In addition to providing tools to understand options better, the invention also provides a new approach to the options term structure charting. With the new design a user can quickly choose the most beneficial expiries to buy and sell as well as which options to trade.

In another embodiment, back tests and forecasts of price direction of an underlying asset are predicted with accuracy. The user can also implement their own formulas into the directional forecast model for instant back testing and future forecasting.

In another embodiment, relative volatility rankings of puts, calls and puts and calls help a user choose which ticker to trade. The user of said volatility calculations also helps a user to predict future price movements.

One embodiment comprises a computer hardware device driven by a processor and in communication with other computer hardware devices over a data communication network.

### BRIEF DESCRIPTION OF THE SEVERAL VIEWS OF THE DRAWINGS

In the following drawings, like reference numbers are used to refer to like elements. Although the following figures depict various examples of the invention, the invention is not limited to the examples depicted in the figures.

FIG. 1 is a relative, interactive term structure chart, which helps a user locate the best months and options to trade, fast and effectively, according to an embodiment.

FIG. 2 depicts “Ticker Picker™” to scan and monitor a plurality of tickers based on volatility ranking formulas using volatility of calls, puts or both calls and puts, according to an embodiment.

FIG. 3 depicts “Up or Down™” for predicting the future price of a plurality of products through back testing a price forecasting formula, according to an embodiment.

FIG. 4 depicts the back test and forward test that is performed on the forecasting formula to determine the % accuracy of the directional signal, according to an embodiment.

FIG. 5 depicts an application to assist a trader with managing their trades, according to an embodiment.

FIG. 6 depicts a trade monitor block for users to compare specific attributes of their positions simultaneously.

FIG. 7 depicts “Study Blocks™” as generally disclosed in U.S. Patent Application No. 61/902,758.

FIG. 8 depicts another design of the Study Blocks. Also note, bubble charts could also be used.

FIG. 9 depicts a format allowing more option contracts to fit on a monitor by overlapping them as transparent and icons.

FIG. 10 depicts the formula configurator block where user can create complex formulas in a very simple way.

FIG. 11 depicts OptionCharts™, which instantly plots historical price and volatility skews of an option or plurality if options.

### DETAILED DESCRIPTION

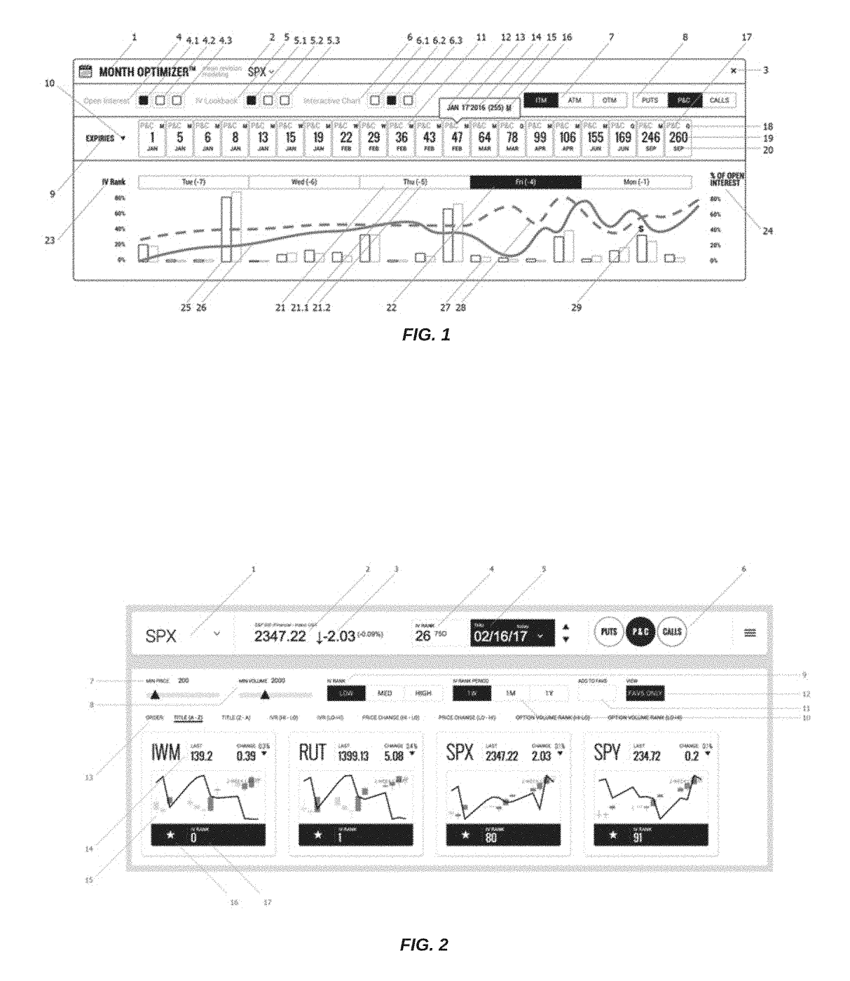

FIG. 1

FIG. 1 is a relative, interactive term structure chart, which helps a user locate the best months and options to trade, fast and effectively. In one embodiment, the chart is generated by an options server device that is driven by a processor and the general computing environment described below. A system can include an options server, a client device, and other network resources, all in communication over a data communication network, such as the Internet. An app can be downloaded to the client device (e.g., a mobile smartphone) for application-layer communication between the client device and the options server.

In one embodiment, the processor displays relative volatility of skews between expiries and various degrees of moneyness of options to the user, as streamed across the data communication network. The new design makes optimization of which expiries and option strikes to buy or sell very simple. The methodology is based on implied volatility reversion, which can be clearly seen through this new, relative volatility term-structure design, according to one embodiment. Some embodiments also include open interest percentages and filters and an interactive feature to view previous dated charts instantly. Users are given insight to current sentiment of the product such as bearish, bullish or neutral by comparison of the relative volatility between calls and puts at each expiration cycle. Sentiment changes over time can be displayed. Users can view various look back periods to locate short, medium and long term skews, but are not limited to the three look back periods. Horizontal and vertical skews become easy to locate and optimize.

The techniques herein also implement color coding for faster recognition of volatility levels. In another embodiment, users can compare multiple products which ware insightful for pairs trading or to predict direction of correlated products.

1. A label for the application.

2. Ticker selector. User can quickly change tickers.

3. Open and close icon for application.

4.1, 4.2, 4.3 are Open Interest selector buttons. User can filter high, medium and low open interest on expiration cycles to locate most liquid expiries quickly.

5.1, 5.2, 5.3 are Implied Volatility (IV) Lookback period controls. User can view 1 day, 1 week or 1 month ranked volatility charts by selecting the assigned radio button. This allows user visually identify short and long-term IV skews between expiration cycles. User can also view how directional sentiment is changing of the underlying product. For example, and IV spike on the CALLS out 100 days to expiration could indicate the market sentiment is bullish for the next 100 days.

6.1, 6.2, 6.3 are Interactive Chart buttons. When selected, user can instantly view previous-dated charts by moving the cursor left and right over the graph. This creates an animated, interactive chart which shows the user how the charts have been changing over time, providing more insight to the underlying product's IV behavior across all expiration cycles.

7. Radio buttons for In The Money (ITM), At The Money (ATM) and Out of the Money (OTM) options. This provides user a method to select moneyness for each expiry which will be used to calculate the ranked IV charts. This functionality allows user to quickly view and locate skews as well as relative skews between expiration cycles based on moneyness. User can bookmark any skew with one click of the expiration-cycle info box. This functionality allows user to create sophisticated IV reversion option trades on a single expiry or across multiple expiries.

8. PUTS, PUTS & CALLS, CALLS selector radio buttons. This allows user to see relative skews between PUTS and CALLS across multiple expiration cycles and at various moneyness selections (ITM, ATM, OTM). In figures, the dashed line represents the IV Rank of the PUTS per user-selected moneyness. The solid line represents the IV Rank of the CALLS per user-selected moneyness.

9. Label for Expiration Cycles row.

10. Drop down menu to allow users to filter days to expiration. For example, if user only wants to see Weeklies or Quarterlies, user can filter those expiries here.

11. Each expiry available per ticker is represented with a selectable object. In this design a horizontal layout is used to correspond with increasing time on the X axis. Each expiry is aligned vertically with its respective IV Rank and Open Interest Rank. Each object displays important information about the expiry such as Puts, Puts and Calls, Calls, expiration type such as weekly, monthly, quarterly, days to expiration and month. Additionally, each expiration object is assigned a color based on the IV Rank of the expiry according to user's selected moneyness value.

12. Pop over indicates Month of expiry.

13. Indicates day of expiry.

14. Indicates year of expiry.

15. Indicates number of days to expiry.

16. Indicates type of expiration cycle such as Weekly, Monthly, Quarterly and PM.

17. Indicates IV Rank of Puts, Calls or Calls & Puts, which is selected by user to be displayed.

18. Indicates type of expiration cycle type such as Weekly, Monthly, Quarterly or PM settlement.

19. Indicates days to expiration of the expiration cycle.

20. Indicates month of the expiration cycle.

21, 21.1, 21.2. When “Interactive Chart” is activated, user can quickly view past charts by moving cursor over past dates as indicated in this row. Information such as Day, Date, lookback duration, etc. can be displayed to user.

22. In this example user views charts of a previous Friday by hovering over with cursor, which was 4 days ago.

23. Label and drill-down button for Y-axis. In this example we plot the IV Rank. User can click the button to switch from IV Rank, IV Percentile or a traditional IV term structure chart.

24. Second Y-axis displays % of Open Interest for each expiration cycle. This information helps user identify which expiries are most liquid to trade. Open Interest can give a trader insight about directional forecasts as well. Higher than usual Open Interest could indicate institutional trading. On click of the label, user can view the numerical Open Interest of each expiry.

25. Bar chart displays % of total Open Interest or Open Interest value for Puts for respective expiry.

26. Line chart displays IV Rank or IV Percentile or IV of selected Calls by user for respective expiry.

27. Bar chart displays % of Open Interest or Open Interest value of Calls for respective expiry.

28. Dashed line displays IV Rank, IV Percentile or IV of selected Puts by user for respective expiry.

29. Indicator shows user has a position on this expiry.

FIG. 2

FIG. 2 depicts “Ticker Picker™”, a new method to scan and monitor a plurality of tickers based on volatility ranking formulas using volatility of calls, puts or both calls and puts. The volatility ranking formula uses various look-back periods to present short term and long term volatility trading opportunities to the user. By ranking the volatility of calls and puts separately, additional information is presented to user other than traditional methods of ranking volatility. Directional sentiment can be recognized through this technology. For example, when the put volatility rank exceeds the call volatility rank, this could indicate that the current sentiment is bearish.

1. Depicts the underlying ticker user has selected in the software.

2. Depicts the current price of the underlying.

3. Depicts the price change of the underlying.

4. Depicts the 75 Day IV Rank of the underlying. Note, the volatility rank look-back period is adjustable, which dates back to patent application 2013.

5. Depicts the date of the data presented to the user.

6. Depicts 3 buttons that allow user to switch between data from puts, puts and calls or calls.

7. Depicts a slider for user to set minimum price of underlying.

8. Depicts a slider for user to set minimum volume of underlying.

9. Depicts 3 buttons with low, medium and high IV Rank selectors for user to locate products to trade based on volatility levels of the puts, puts and calls or calls only. Only 3 levels are shown, but the invention is not limited to these 3.

10. Depicts 3 buttons with 1 week, 1 month and 1 year look-back period of which to calculate the current volatility rank. This provides a user with short term or longer term volatility trading opportunities. Although 3 buttons are shown, the invention is not limited to these 3 settings.

11. Depicts an input area for user to enter tickers of favorite products to trade.

12. Depicts a button to show user's favorites only and to hide all other tickers.

13. Depicts various attributes of which user can sort including, but not limited to title, IV Rank, Price Change and Volume Rank.

14. Depicts current price of ticker.

15. Depicts 2 week price chart of ticker.

16. Depicts icon for user to select or deselect a favorite.

17. Depicts IV Rank of the puts, puts and call or calls, as chosen by user. Not shown, but next to IV Rank should be the Volume Rank.

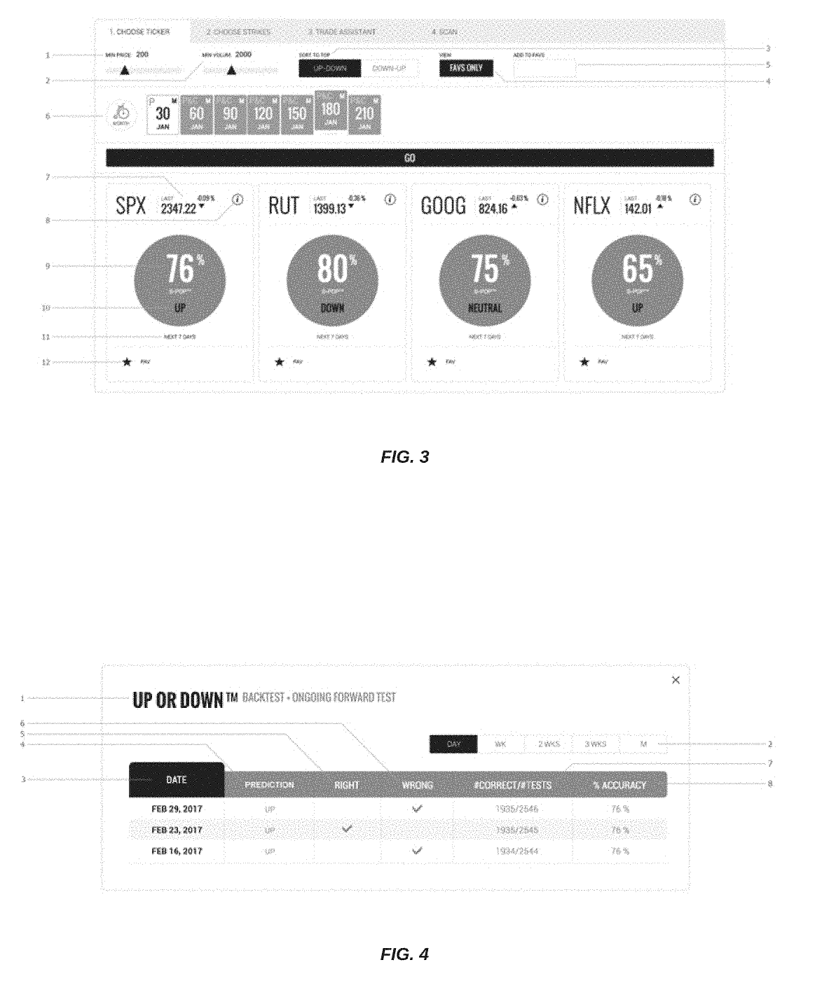

FIG. 3

FIG. 3 depicts “Up or Down™”, a new invention that predicts the future price of a plurality of products through back testing a price forecasting formula. Back testing is described in further detail in U.S. application Ser. No. 14/312,662. The accuracy of the back test is then displayed to the user. The forward test is also added into the statistical probability (S-POP™) of the prediction each time it makes a prediction. The techniques guide a trader through trades in a more simplified design than a price chart. The user saves time because a formula is provided one time, and then the user does not need to repeatedly study price charts to calculate the same information over and over again. Various formulas can be fed through this final output, and formulas can be defined by user. The algorithms can back test the user's own formulas and show them the S-POP™ of their prediction for each product. The user can enter as many formulas into the system as desired to develop the most accurate system. In one embodiment, the software could include a formula(s) for the end user.

1. Depicts slider for user to set minimum price of tickers to scan.

2. Depicts slider for user to set minimum volume of tickers to scan.

3. Depicts button for user to order the Up or Down™ statistical probability from up to down or reversed.

4. Depicts button for user to view favorites only.

5. Depicts button for user to add new tickers to favorites.

6. Depicts button to launch the relative term structure chart with all expiration cycles.

7. Depicts information such as ticker, las price and change of price.

8. Depicts icon button to launch more information such as backtests performed and forward tests of directional accuracy.

9. Display of forecast formula's % accuracy according to the back tests+forward test results. Since the formula is tested, the results are labeled S-POP™ for statistical probability.

10. Depicts the directional forecast, UP, DOWN or NEUTRAL.

11. Depicts the number of days of the forecast. This also acts as a button. User can change the number of days of the forecast.

12. Depicts an icon for user to label tickers as favorites and uncheck them as needed.

FIG. 4

FIG. 4 depicts the back test and forward test that is performed on the forecasting formula to determine the % accuracy of the directional signal.

1. Title for information block.

2. Depicts buttons for user to change the forecast period of time such as 1 day, 1 week, 2 weeks, 3 weeks, 1 month. The software backtests and forward tests each time frame to produce the reports.

3. Depicts the date of the backtests and coward-tests.

4. Depicts the direction of the forecast.

5. Depicts instances when the price change forecast was right.

6. Depicts the instances when the forecasted price change was incorrect.

7. Depicts number of correct predictions and number of total predictions.

8. Depicts the % accuracy of the forecasts.

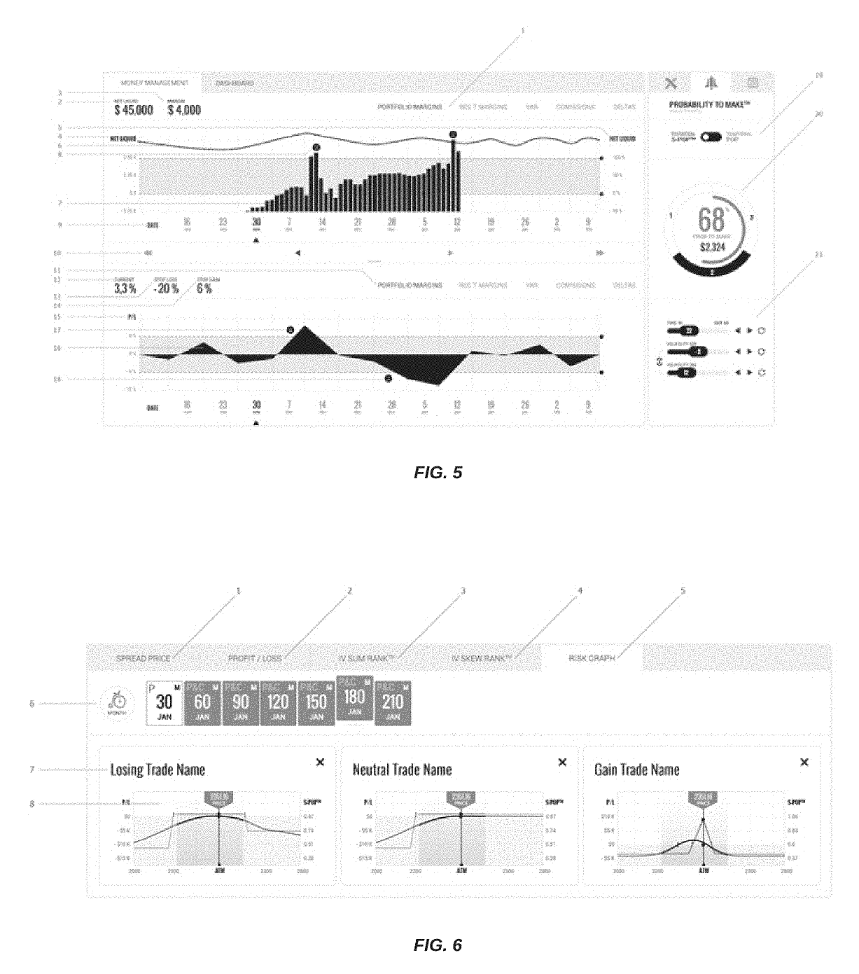

FIG. 5

FIG. 5 depicts an application to assist a trader with managing their trades. Many traders fail because they over leverage or do not have a trading plan to follow. Tools are provided for users to create their own money management rules, presents risk to them versus margins to help them avoid margin calls and provides them with tools to create and follow a plan for each trade. More specifically, charts and interactive tools are provided for a user to visualize various types of margins, value at risk (VAR), commissions as well as individual trades of an entire portfolio (for example, as in U.S. application Ser. No. 14/312,662. In one embodiment, the top chart represents money management such as how much capital to invest, risk vs. net account value (NAV) and the bottom chart represents trade management such as when to exit trade based on profits and losses, margins and commissions. User can easily see if they NAV gets close to the margin maintenance and they can also see when their trades hit stop losses and gains, as well as keep track of the entire history of each. User can also visualize their account growth and max drawdowns vs the risk they are taking.

1. Depicts menu for user to control output of chart. Portfolio Margins and Reg T Margins will present amount of trading capital in account. VAR calculates Value at Risk and charts this vs the account NAV. Commissions will chart user's commission history. The invention is not limited to these charts.

2. Depicts the Net Liquidation Value of the account.

3. Depicts the margin requirement for trade(s) user is viewing.

4 and 5 depict the Y axis, presenting the Net Liquid Value of the account in dollars and %.

6. Depicts a line chart of the Net Liquidation Value through time.

7. Depicts a bar chart of the margin requirement through time. User can see if margins are near account value. A crossing would represent a margin call.

8. Depicts an indication of a margin call. The margins went above the account value.

9. Depicts the x axis, which plots time.

10. Depicts navigation bars to see more time to the left and right.

11. Depicts navigation for the bottom chart, which is charting specified trades input by the user.

12. Depicts the current trade is profitable 3.3%.

13. Depicts user has stop loss placed at −20% for shown trade.

14. Depicts user has stop gain placed at 6%.

15. Depicts Y-axis which plots the profit and loss of the trade(s).

16. Depicts the historical profit and loss of the trade(s).

17. Depicts an icon to show user reached the stop gain.

18. Depicts an icon to show user hit the stop loss.

19. Depicts a switch for user to choose S-POP™ or POP for the probability zone model (previous patent)

20. Depicts probability controls and backtested calculations showing user probable profits and losses.

21. Depicts controls for user to apply changes of time and volatility into the modeling.

FIG. 6

FIG. 6 depicts a trade monitor block for users to compare specific attributes of their positions simultaneously. This can be helpful to monitor Greek positions, volatility, VAR, profits and losses, margins and much more individually and together at the same time.

1. Depicts a menu item, Spread Price. In this view user can see the spread price history of all positions. This can be helpful in timing entry and exit of any trade.

2. Depicts a menu item, Profit/Loss. User can see historical profit and loss charts of all positions. This can be helpful in timing entry and exit points and much more.

3. Depicts a menu item, IV SUM RANK™. This invention allows user to see the historical volatility sum of all contracts of their positions. This can be helpful to time entry and exit points.

4. Depicts a menu item, IV SKEW RANK™. This invention plots the historical skew between short and long contract for user, which can be helpful to time entry and exit points.

5. Depicts a menu item, Risk Graph. This plots the risk profile of all positions.

6. Depicts an icon, which launches the relative term structure block.

7. Depicts titles of each trade, chosen by the user.

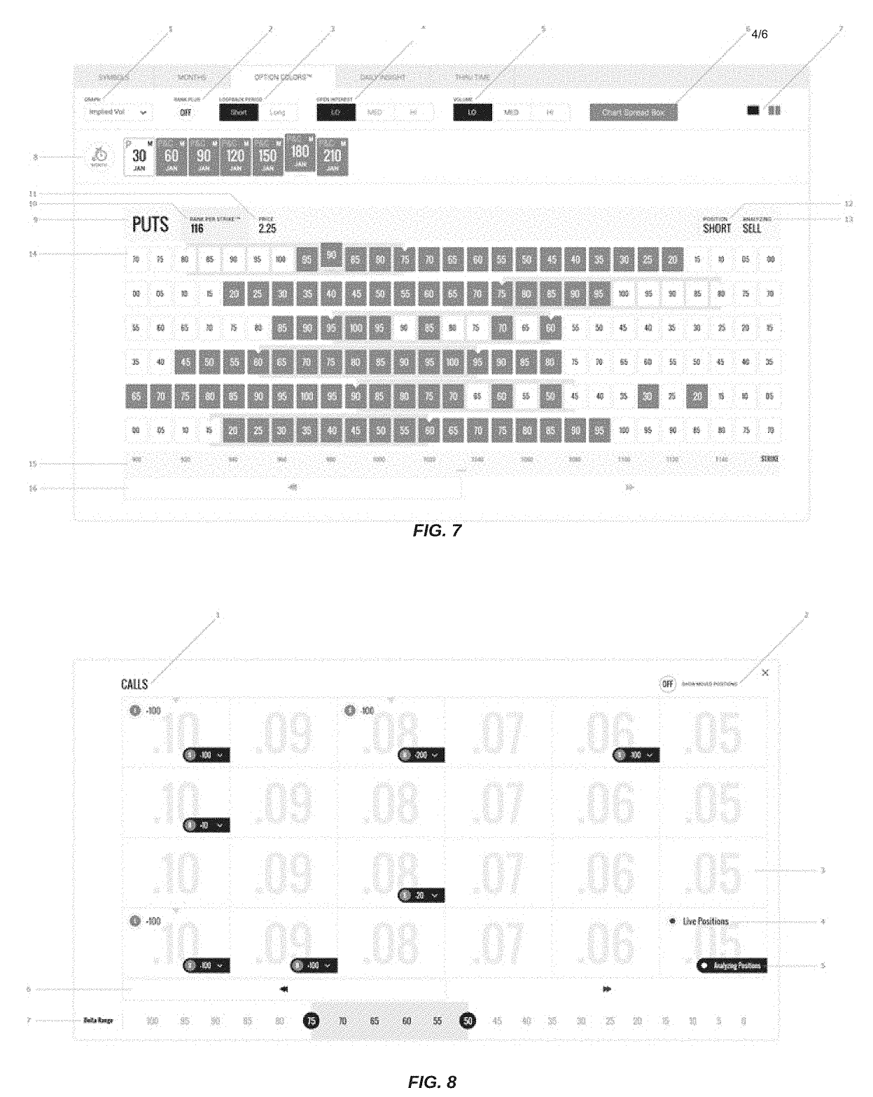

FIG. 7

FIG. 7 depicts “Study Blocks™” as generally disclosed in U.S. Patent Application No. 61/902,758. The current technique expands on the compare volatility ranks of a plurality of options through a visual design. Study Blocks uses a similar visual output as the original invention, but in this embodiment, we provide users with a formula creator block, a simple method to create unlimited formulas to compare option attributes across a plurality of options. For example, if a user wants to see which options decay the fastest, they could create the theta/optionPrice formula and apply this formula to thousands of options and multiple assets. If a user wishes to compare the risk of options, they could look at gamma/optionPrice, where a higher number would represent more volatile options. With this invention, a user could determine the most favorable options to sell and buy in seconds, according to the user's own preferences. A user can also study the behavior of options over a period of time. For example, if user wants to see which options were most profitable over the last month, user can compare all relative prices over a 30 day period by comparing optionPrice and choosing a loopback period of one month. This invention has endless possibilities. Users can build trades right from the Study Blocks. User can compare attributes across multiple assets as well by popping over another Study Block panel. Never before has it been so easy to compare options before and know which to sell and buy.

1. Depicts a drop down menu with default formulas and user-created formulas, which can be applied to thousands of options for comparison.

2. Depicts Rank Plus™ button for user to toggle between value and relative values, such as rank or percentile.

3. Depicts preset loopback periods for user to assign to their formulas, which is used to compare how options change over time. 2 presets are shown, but the invention is not limited to these 2.

4. Depicts open interest filters.

5. Depicts volume filters.

6. Depicts a button for user to display their positions.

7. Depicts buttons for user to change the view from single chart to multiple charts.

8. Depicts the icon to open the relative term structure chart.

9. Depicts puts or calls as a label.

10. Depicts the RANK PER STRIKE™. In this example, volatility rank is displayed.

11. Depicts an options price.

12. Depicts user has a long or short position.

13. Depicts user is analyzing a new position either buy or sell.

14. Depicts a value, rank or percentile displayed in each cell, which represents the value of the formula user is comparing across all options. Each cell is also color-coded for user to quickly recognize high, medium and low values.

15. Depicts the X-axis, which plots the option strike prices.

16. Depicts a navigation bar for user to scroll left and right to see more strikes as needed.

FIG. 8

FIG. 8 depicts another design of the Study Blocks. Also note, bubble charts could also be used. Many other variations are possible.

1. Depicts the label of calls or puts.

2. Depicts a button to view a line to connect positions that have been rolled to a new location.

3. Depicts a value, rank or percentile printed inside the cell of an option strike, created by the formula.

4. Indicates that top left of cell depicts a live position.

5. Indicates that bottom right depicts a position user is analyzing.

6. Depicts a navigation bar to scroll left and right.

7. Depicts X-axis with delta range controls to change range of deltas displayed on the chart.

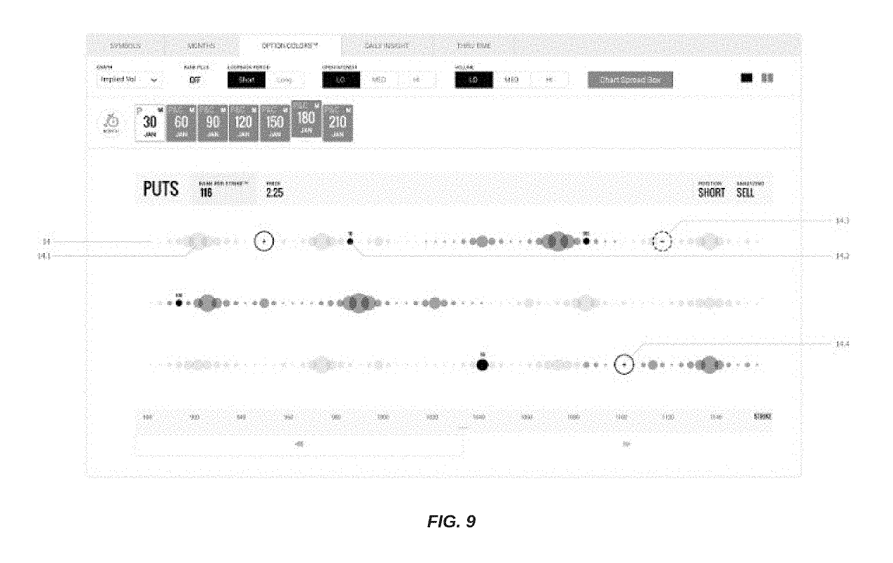

FIG. 9

FIG. 9 depicts a format allowing more option contracts to fit on a monitor by overlapping them as transparent and icons. Color and various sizes represent values of the formulas.

14.1 Depicts transparent icons which resize dynamically and change color to indicate values created by the formulas.

14.2 Depicts a user live position.

14.3 Depicts a potential position a user is analyzing to sell.

14.4 Depicts a potential position a user is analyzing to buy.

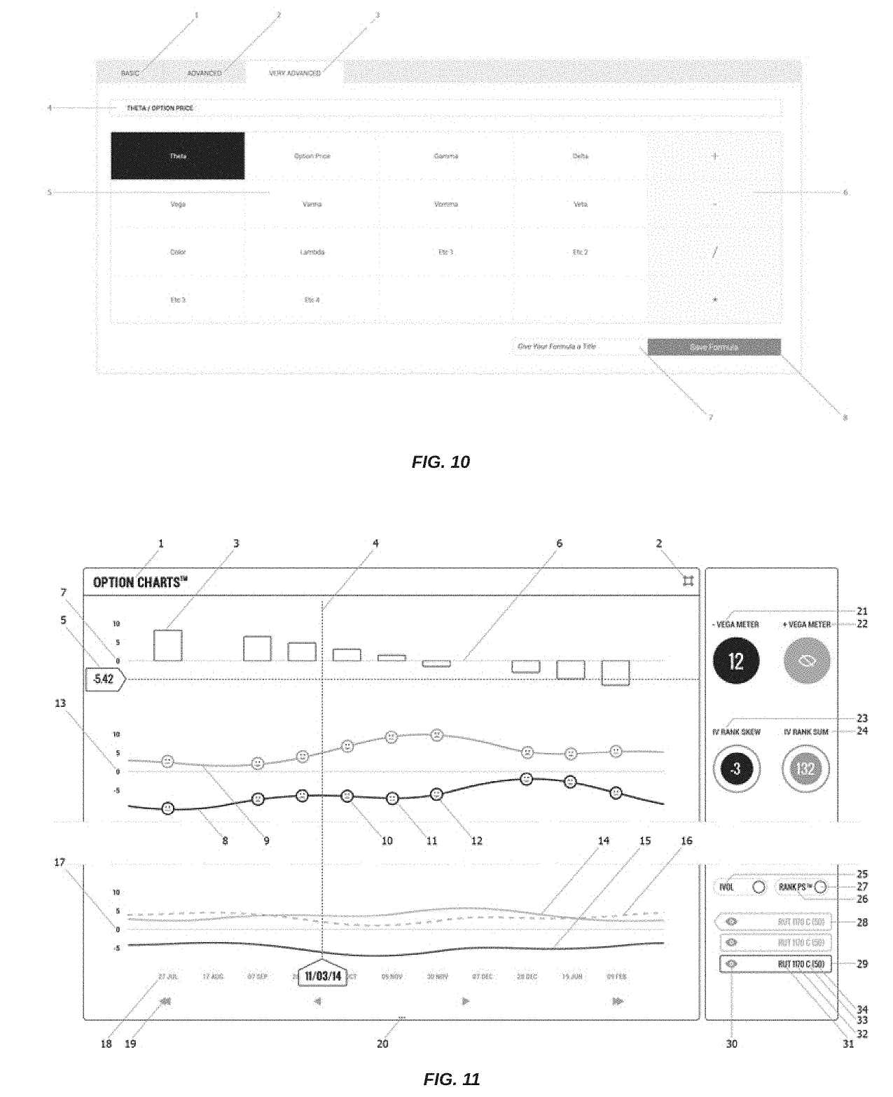

FIG. 10

FIG. 10 depicts the formula configurator block where user can create complex formulas in a very simple way. User can create formulas such as but not limited to compare risk, compare decay rates, compare which option prices change the most, which change the least, compare relative vega, compare relative lambda, compare relative vega, etc. Users can create an unlimited number of formulas.

1. 2. 3. Depicts a menu, Basic, Advanced and Very Advanced. The invention can provide presets to user and allow them to create their own formulas. We may use tabs to organize the formulas for users.

4. Depicts a formula chosen by user.

5. Depicts buttons that contain various option Greeks, prices, volatility, etc. There are many attributes related to options which can be contained in the configurator. The invention is not limited to these attributes.

6. Depicts mathematical symbols such as +, −, /, * so user can easily create mathematical formulas.

7. Depicts an input form for user to save math expression with a title.

8. Depicts a button for user to save the formula.

FIG. 11

FIG. 11 depicts OptionCharts™, which instantly plots historical price and volatility skews of an option or plurality if options. Value charts and relative charts are generated. Additionally, an automated algorithm generates a signal chart, which gives entry and exit signals to a trader, based on complex volatility or price calculations. In one embodiment, the signal chart could be used as a stand-alone application, making a complex topic extremely simple. For example, if a user is looking at a −Vega position, they would receive an entry signal through a tall bar chart, color-coded, when the optimized time is present. This is an effective tool in combination with back testing of this signal chart. More details is disclosed in U.S. Patent Application No. 61/902,758.

1. Depicts the title for the invention.

2. Depicts a button to open the block in a new window.

3. Depicts a historical bar chart of entry and exit signals. In one embodiment, when the bar is tall, it indicates and entry signal. When the bar is short or negative, it indicates an exit signal. The signals work for both positive and negative Vega option positions.

4. Depicts cursor location of the X-axis.

5. Depicts cursor location of the Y-axis.

6. Depicts the 0-line of the signal bar chart.

7. Depicts the values of the Y-axis of the signal chart.

8. Depicts a historical skew chart of price or volatility of options contract, either value or relative, according to user selection. The skew is calculated for unlimited option contracts.

9. Depicts a price or volatility sum chart, by value or rank. The sum chart is calculated for unlimited option contracts.

10. 11. 12. Depict icons to indicate whether the skew is positive or negative.

13. Depicts the 0-line of the skew and sum charts.

14. 15. Depict the historical price or volatility chart, either value or relative, of a user's long option positions.

16. Depicts the historical price or volatility chart, either value or relative, of a user's short option position(s).

17. Depicts the 0-line of the historical price and volatility charts of options.

18. Depicts the X-axis, which represents time.

19. Depicts navigation elements for user to change the time viewed on the X-axis.

20. Depicts a element for user to resize the chart.

21. Depicts a −Vega Meter button for user to read signal rating for a −Vega options position.

22. Depicts a +Vega Meter button for user to read signal rating for a +Vega options position.

23. Depicts an IV Rank Skew button for user to read the IV Rank Skew of the options position.

24. Depicts and IV Rank Sum button for user to read the IV Rank Sum of the options position.

25. Depicts a button for user to choose between volatility (IVOL) and price.

26. 27. Depicts a button for user to choose between ranked charts or value charts.

28. Depicts the option contracts not included in the charts calculations (OFF position).

29. Depicts ON position. Option contract is shown on chart and included in calculations. These contracts instantly appear on the panel according to user positions. No manual construction is required.

30. Depicts icon element to include or not include option in chart calculations.

31. 32. 33. 34. Depict information related to the option contract.

### Hardware Embodiments

The disclosure can be implemented in, for example, an options server computing device coupled to a computer network such as the Internet or other wide area network to allow connections from remotely connected user computing devices.

The options server can include an implied volatility module, a price change module, and a user interface module, among other components, in electrical communication with processors, memory devices, network interface apparatus, and other components. The computing devices can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

### GENERALITIES OF THE DISCLOSURE

More generally, the various features described in association with specific embodiments are non-limiting, as features can be interchanged between the embodiments if appropriate. As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the invention or its features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

I claim:

1. A computer-implemented method in an options trading server of generating statistical price distribution superimposed over a risk profile, the method comprising the steps of:
receiving a selection of an underlying asset for a price statistical analysis concerning a potential trade;
receiving a time period for historical price data for the underlying asset during the time period;
generating a price histogram by normalizing historical price data by converting price value differences to percentage value differences;
receiving current price data for the underlying asset;
receiving a time period for the price statistical analysis of the potential trade;
receiving an option trade for the underlying asset;
generating a risk profile from the option trades;
superimpose the price histogram over a risk profile for the selected time period; and
outputting probability values for various profits corresponding to the risk profile.
